(19) United States
(12) Patent Application Publication
(10) Pub. No.: US 2025/0118048 A1
(43) Pub. Date: Apr. 10, 2025

(54) Apparatus for Controlling a Vehicle and Method Thereof

(71) Applicants: Hyundai Motor Company, Seoul (KR); Kia Corporation, Seoul (KR)

(72) Inventor: Mi Rim Noh, Jeonju-Si (KR)

(21) Appl. No.: 18/735,393

(22) Filed: Jun. 6, 2024

(30) Foreign Application Priority Data
Oct. 4, 2023 (KR) 10-2023-0131868

(51) Int. Cl. G06V 10/46; G06V 10/44; G06V 10/98; G06V 20/58

(52) U.S. Cl. CPC G06V 10/46; G06V 10/44; G06V 10/993; G06V 20/58

(57) ABSTRACT

The present disclosure relates to an apparatus for controlling a vehicle and a method thereof. The vehicle control apparatus may include a light detection and ranging (LiDAR) configured to a plurality of first points corresponding to an external vehicle, and a processor. The processor may determine whether a distribution of first contour points included in a first virtual box associated with the plurality of first points is in one of specified shapes on a plane, may identify a contour point set including a global minimum contour point, may generate a second virtual box based on second contour points, which are obtained by excluding the contour point set, from among the first contour points, and may perform a validation check on the second virtual box.

### CROSS-REFERENCE TO RELATED APPLICATION

This application claims the benefit of priority to Korean Patent Application No. 10-2023-0131868, filed in the Korean Intellectual Property Office on Oct. 4, 2023, the entire contents of which are incorporated herein by reference.

### TECHNICAL FIELD

The present disclosure relates to an apparatus for controlling a vehicle and a method thereof, and more specifically, relates to a technology for identifying an external object (e.g., by using light detection and ranging (LiDAR) and/or other sensors).

### BACKGROUND

Various studies are being conducted to identify an external object by using various sensors to assist a host vehicle in driving.

In particular, while the host vehicle is driving in a driving assistance device activation mode or an autonomous driving mode, the external object may be identified by using one or more sensors (e.g., a LiDAR device, camera, etc.).

When identifying an external vehicle by using the LiDAR device, noise may be generated by external objects (e.g., a lane, a curb, a cat's eye, or a protruding object) adjacent to an external vehicle. While a virtual box for outputting an external vehicle is formed, noise identified together with the external vehicle may be identified as points corresponding to the external vehicle.

When a single virtual box is created based on the external vehicle and the noise, a heading direction or a speed of the virtual box may be incorrectly measured, and thus an error may occur in a vehicle control system including a vehicle control apparatus of the host vehicle. Accordingly, there is a need to resolve the error.

### SUMMARY

The following summary presents a simplified summary of certain features. The summary is not an extensive overview and is not intended to identify key or critical elements.

An aspect of the present disclosure provides a vehicle control apparatus that improves the location accuracy of an external vehicle by removing points corresponding to noise and then creating a virtual box, and a method thereof.

An aspect of the present disclosure provides a vehicle control apparatus that improves the accuracy of at least one of a longitudinal speed, or a lateral speed, or any combination thereof of the external vehicle by removing points corresponding to noise and then creating a virtual box, and a method thereof.

An aspect of the present disclosure provides a vehicle control apparatus that stably outputs a heading direction of a virtual box corresponding to the external vehicle by removing points corresponding to noise and then creating a virtual box, and a method thereof.

The technical problems to be solved by the present disclosure are not limited to the aforementioned problems, and any other technical problems not mentioned herein will be clearly understood from the following description by those skilled in the art to which the present disclosure pertains.

An apparatus may comprise: a sensor configured to obtain sensing information associated with a plurality of first points corresponding to an external vehicle; and a processor configured to: determine whether a distribution of first contour points included in a first virtual box associated with the plurality of first points corresponds to one of specified shapes on a plane, wherein the plane is formed by a first axis and a second axis, in a space formed by the first axis, the second axis, and a third axis; determine a contour point set including a global minimum contour point, wherein the global minimum contour point is one of local minimum contour points and has the smallest distance among distances between a reference line segment and the local minimum contour points, wherein the local minimum contour points are determined, from among the first contour points, based on the smallest distance among distances between the first contour points and one of line segments forming the first virtual box, wherein the reference line segment corresponds to the one of the line segments forming the first virtual box and corresponds to a rear surface or a side surface of the external vehicle, wherein the first contour points are included in each of a plurality of first layers, and wherein the plurality of first layers are included in the first virtual box and formed in a direction of the third axis; generate a second virtual box based on second contour points, wherein the second contour points are obtained by excluding the contour point set, from among the first contour points; and perform a validation check on the second virtual box based on at least one of: a difference between a first width of the first virtual box and a second width of the second virtual box, a difference between a first number of times that the distribution of the first contour points included in the first virtual box is identified as being in one of the specified shapes and a second number of times that a distribution of the second contour points included in the second virtual box is identified as being in one of the specified shapes, or a difference between a number of the plurality of first points included in the first virtual box and a number of a plurality of second points included in the second virtual box.

The processor may be configured to: output the second virtual box based on the second virtual box being identified as being valid after the validation check; or output the first virtual box based on the second virtual box being identified as being invalid after the validation check.

The processor may be configured to: determine that a line segment of the first virtual box corresponding to a rear surface of the external vehicle is the reference line segment, based on the distribution of the first contour points included in the first virtual box being identified as being in a first shape among the specified shapes; and identify the local minimum contour points on the plurality of first layers based on a width of the first virtual box exceeding a first reference width and a length of the first virtual box exceeding a first reference length.

The apparatus may further comprise a memory. The processor may be configured to: store, in the memory, information associated with a layer, on which the global minimum contour point is identified, from among the plurality of first layers.

The processor may be configured to: based on a distance between the reference line segment and each of the local minimum contour points included in each of the plurality of first layers exceeding a f first reference distance, form a plurality of second layers different from the plurality of first layers by setting a layer including a minimum value of the direction of the third axis as a minimum layer based on identifying the minimum value of the direction of the third axis among the second contour points; and generate the second virtual box based on the second contour points included in the plurality of second layers.

The processor may be configured to: identify, on each of the plurality of first layers, a partial shape included in a second shape based on a distance between each of the first contour points and a line segment connecting a minimum value and a maximum value of a direction of the second axis of the first contour points being identified as being within a reference distance, wherein the distribution of the first contour points included in the first virtual box is identified as being in the second shape different from a first shape among the specified shapes; and identify layers including the partial shape among the plurality of first layers.

The reference line segment may include a first reference line segment. The processor may be configured to: identify, as the first reference line segment, a line segment, which has the greatest distance from points forming the partial shape, from among line segments, which correspond to side surfaces of the external vehicle and are used to form the first virtual box, on at least one of layers including a partial shape; identify a first distance, which is smallest, from among distances of the first contour points from the first reference line segment, and a second distance, which is smallest, from among distances of the first contour points from a second reference line segment facing the first reference line segment among line segments forming the first virtual box on at least one layer, on which a partial shape is not identified, from among the plurality of first layers; identify the global minimum contour point forming the first distance based on the first distance being identified as being smaller than the second distance; obtain the contour point set including the global minimum contour point based on identifying the global minimum contour point; identify a minimum value of the direction of the third axis among the second contour points based on the second contour points, which are obtained by excluding the contour point set, from among the first contour points; and form a plurality of second layers different from the plurality of first layers by setting a layer including the minimum value of the direction of the third axis as a minimum layer.

The processor may be configured to: identify a distance between the reference line segment and line points, which are included in a line box and to each of which a first identifier indicating a line is assigned, from among the plurality of first points; identify an invalid box having a second identifier indicating that the distribution of the first contour points is not in one of the specified shapes; and store, in the memory, at least one of the second contour points, which are obtained by excluding at least part of the first contour points overlapping the line points, from among the first contour points, or the second contour points, which are obtained by excluding invalid points included in the invalid box, from among the first contour points, or any combination thereof.

The processor may be configured to: form a plurality of second layers different from the plurality of first layers by setting a layer including a minimum value of the direction of the third axis as a minimum layer based on identifying the minimum value of the direction of the third axis among the second contour points; and generate the second virtual box based on the second contour points included in the plurality of second layers.

The processor may be configured to: identify that the second virtual box is valid, based on the difference between the first width of the first virtual box and the second width of the second virtual box being greater than or equal to a second reference width, the second number of times that the distribution of the second contour points included in the second virtual box identified as being in one of the specified shapes being greater than or equal to the first number of times that the distribution of the first contour points included in the first virtual box identified as being in one of the specified shapes, and the difference between the number of the plurality of first points included in the first virtual box and the number of the plurality of second points included in the second virtual box being smaller than or equal to a reference ratio.

The apparatus may perform one or more methods described herein. For example, a method may comprise: determining, by an apparatus, whether a distribution of first contour points included in a first virtual box associated with a plurality of first points corresponds to one of specified shapes on a plane, wherein the plane is formed by a first axis and a second axis, in a space formed by the first axis, the second axis, and a third axis, and wherein the plurality of first points corresponds to an external vehicle and obtained based on sensing information of a sensor; determining a contour point set including a global minimum contour point, wherein the global minimum contour point is one of local minimum contour points and has the smallest distance among distances between a reference line segment and the local minimum contour points, wherein the local minimum contour points are determined, from among the first contour points, based on the smallest distance among distances between the first contour points and one of line segments forming the first virtual box, wherein the reference line segment corresponds to the one of the line segments forming the first virtual box and corresponds to a rear surface or a side surface of the external vehicle, wherein the first contour points are included in each of a plurality of first layers, and wherein the plurality of first layers are included in the first virtual box and formed in a direction of the third axis; generating a second virtual box based on second contour points, wherein the second contour points are obtained by excluding the contour point set, from among the first contour points; and performing a validation check on the second virtual box based on at least one of: a difference between a first width of the first virtual box and a second width of the second virtual box, a difference between a first number of times that the distribution of first contour points included in the first virtual box is identified as being in one of the specified shapes and a second number of times that a distribution of the second contour points included in the second virtual box is identified as being in one of the specified shapes, or a difference between a number of the plurality of first points included in the first virtual box and a number of a plurality of second points included in the second virtual box, or any combination thereof.

The apparatus s may perform one or additional operations described herein.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram of a vehicle control apparatus, according to an example of the present disclosure;

FIG. 2 shows an example of identifying a partial shape in an example of the present disclosure;

FIG. 3 shows an example of obtaining a contour point set, in an example of the present disclosure;

FIG. 4 shows an example of obtaining a contour point set, in an example of the present disclosure;

FIG. 5 shows an example associated with an invalid box, in an example of the present disclosure;

FIG. 6 shows an example associated with a line box, in an example of the present disclosure;

FIG. 7 shows an example of forming a plurality of second layers including second contour points, in an example of the present disclosure;

FIG. 8 shows an example associated with a flowchart of a vehicle control method, according to an example of the present disclosure;

FIG. 9 shows an example associated with a flowchart of a vehicle control method, according to an example of the present disclosure;

FIG. 10 shows an example of a result of applying the present disclosure;

FIG. 11 shows an example of a result of applying the present disclosure; and

FIG. 12 illustrates a computing system associated with a vehicle control apparatus or vehicle control method, according to an example of the present disclosure.

### DETAILED DESCRIPTION

Hereinafter, some examples of the present disclosure will be described in detail with reference to the accompanying drawings. In adding reference numerals to components of each drawing, it should be noted that the same components have the same reference numerals, although they are indicated on another drawing. Furthermore, in describing the examples of the present disclosure, detailed associated with well-known functions or configurations will be omitted when they may make subject matters of the present disclosure unnecessarily obscure.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as having a meaning that is consistent with their meaning in the context of the present disclosure and the relevant art and will not be interpreted in an idealized or overly formal sense unless expressly so defined herein.

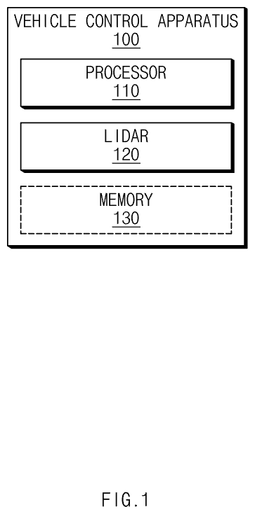

Hereinafter, various examples of the present disclosure will be described in detail with reference to FIGS. 1 to 12.

FIG. 1 shows an example of a block diagram of a vehicle control apparatus, according to an example of the present disclosure.

Referring to FIG. 1, a vehicle control apparatus 100 according to an example of the present disclosure may be implemented inside or outside a vehicle, and some of components included in the vehicle control apparatus 100 may be implemented inside or outside the vehicle. At this time, the vehicle control apparatus 100 may be integrated with internal control units of a vehicle and may be implemented with a separate device so as to be connected to control units of the vehicle by means of a separate connection means. For example, the vehicle control apparatus 100 may further include components not shown in FIG. 1.

Referring to FIG. 1, the vehicle control apparatus 100 according to an example may include a processor 110 and a LiDAR 120. According to an example, the vehicle control apparatus 100 may further include a memory 130. The processor 110, the LiDAR 120, or the memory 130 may be electrically and/or operably coupled with each other by an electronic component including a communication bus.

Hereinafter, the fact that pieces of hardware are coupled operably may include the fact that a direct and/or indirect connection between the pieces of hardware is established by wired and/or wirelessly such that second hardware is controlled by first hardware among the pieces of hardware.

Although different blocks are shown, an example is not limited thereto. Some of the pieces of hardware in FIG. 1 may be included in a single integrated circuit including a system on a chip (SoC). The type and/or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to an example may include hardware for processing data based on one or more instructions. The hardware for processing data may include the processor 110.

For example, the hardware for processing a piece of data or pieces of data may include an arithmetic and logic unit (ALU), a floating point unit (FPU), a field programmable gate array (FPGA), a central processing unit (CPU), and/or an application processor (AP). The processor 110 may have a structure of a single-core processor, or may have a structure of a multi-core processor including a dual core, a quad core, a hexa core, or an octa core.

The LiDAR 120 of the vehicle control apparatus 100 according to an example may obtain data sets from identifying objects surrounding a host vehicle including the vehicle control apparatus 100. For example, the LiDAR 120 may identify at least one of a location of the surrounding object, a movement direction of the surrounding object, or a speed of the surrounding object, or any combination thereof based on a pulse laser signal emitted from the LiDAR 120 being reflected by the surrounding object and returned.

For example, the LiDAR 120 may obtain data sets including a plurality of points in the space defined by a first axis, a second axis, and a third axis based on a pulse laser signal reflected from surrounding objects. For example, the LiDAR 120 may obtain data sets including a plurality of points in the space, which is formed by the first axis, the second axis, and the third axis, based on receiving the pulse laser signal at a specified period. For example, the first axis may include an x-axis. For example, the second axis may include a y-axis. For example, the third axis may include a z-axis. However, the first axis, the second axis, and/or the third axis is not limited to the above examples.

The processor 110 of the vehicle control apparatus 100 according to an example may emit light from a host vehicle by using the LiDAR 120. For example, the processor 110 may receive light emitted from the host vehicle. For example, the processor 110 may identify at least one of a location, a speed, or a moving direction, or any combination thereof of a surrounding object based on a time required to transmit light emitted from the host vehicle and a time required to receive light emitted from the host vehicle.

For example, the processor 110 may obtain data sets including a plurality of points based on the time required to transmit light emitted from the host vehicle and the time required to receive light emitted from the host vehicle. The processor 110 may obtain data sets for expressing a plurality of points in a three-dimensional virtual coordinate system including the first axis, the second axis, and the third axis.

The processor 110 included in the vehicle control apparatus 100 according to an example may obtain a plurality of first points corresponding to an external vehicle through the LiDAR 120.

In an example, the processor 110 may determine whether the distribution of first contour points included in a first virtual box created by a plurality of first points is in one of specified shapes on a plane, which is formed by the first axis and the second axis, in the space formed by the first axis, the second axis, and the third axis.

For example, the first axis may include an x-axis. For example, the second axis may include a y-axis. For example, the third axis may include a z-axis. For example, the specified shapes may include a first shape and a second shape. For example, the first shape may include an L-shape. For example, the second shape may include an I-shape. For example, the first contour points may be included in a plurality of first points.

In an example, the processor 110 may identify a plurality of first layers, which are included in a first virtual box and which are formed in a third axis direction. The processor 110 may identify a contour point set including a global minimum contour point having the smallest length between a reference line segment and local minimum contour points from among the local minimum contour points, based on identifying the local minimum contour points having the smallest length between the first contour points and the reference line segment among line segments forming a first virtual box, from among the first contour points included on each of the plurality of first layers, which are included in the first virtual box and which are formed in a direction of the third axis.

For example, the reference line segment may include a line segment corresponding to a rear surface or a side surface of the external vehicle among the line segments forming the first virtual box.

In an example, the processor 110 may exclude a contour point set including a global minimum contour point from among the first contour points. The processor 110 may identify second contour points, which are obtained by excluding the contour point set including the global minimum contour point, from among the first contour points. The processor 110 may create a second virtual box based on the second contour points, which is obtained by excluding the contour point set including the global minimum contour point, from among the first contour points.

In an example, the processor 110 may perform a validation check on the second virtual box based on at least one of a difference between a first width of the first virtual box and a second width of the second virtual box, a difference between the first number of times that a distribution of the first contour points included in the first virtual box is identified as being in one of specified shapes, and the second number times that a distribution of the second contour points included in the second virtual box is identified as being in one of the specified shapes, or a difference between the number of first points included in the first virtual box and the number of second points included in the second virtual box, or any combination thereof.

In an example, the processor 110 may determine whether the a between a first width of the first virtual box and a second width of the second virtual box is greater than or equal to a second reference width. The processor 110 may determine whether the second number of times that the distribution of the second contour points included in the second virtual box is identified as being in one of the specified shapes is greater than or equal to the first number of times that the distribution of the first contour points included in the first virtual box is identified as being in one of specified shapes. The processor 110 may determine whether the difference between the number of first points included in the first virtual box and the number of second points included in the second virtual box is smaller than or equal to a reference ratio.

In an example, the processor 110 may identify that the second virtual box is valid, based on the fact that the difference between the first width of the first virtual box and the second width of the second virtual box is greater than or equal to a second reference width, the second number of times that a distribution of the second contour points included in the second virtual box identified as being in one of the specified shapes is greater than or equal to the first number of times that a distribution of the first contour points included in the first virtual box identified as being in one of the specified shapes, and the difference between the number of a plurality of first points included in the first virtual box and the number of a plurality of second points included in the second virtual box is smaller than or equal to the reference ratio.

In an example, the processor 110 may identify that the second virtual box is invalid, based on the fact that the difference between the first width of the first virtual box and the second width of the second virtual box is smaller than the second reference width, the second number of times that the distribution of the second contour points included in the second virtual box identified as being in one of the specified shapes is smaller than the first number of times that the distribution of the first contour points included in the first virtual box identified as being in one of the specified shapes, or the difference between the number of a plurality of first points included in the first virtual box and the number of a plurality of second points included in the second virtual box exceeds the reference ratio.

In an example, the processor 110 may output the second virtual box based on the second virtual box being identified as being valid through the validation check. In an example, the processor 110 may output the first virtual box based on the second virtual box being identified as being invalid through the validation check.

Hereinafter, an example of obtaining a second virtual box based on the distribution of first contour points included in the first virtual box identified as being in a first shape (e.g., L-shape) among specified shapes will be described later.

In an example, the processor 110 may identify that a line segment of the first virtual box corresponding to a rear surface of the external vehicle is a reference line segment, based on the distribution of the first contour points included in the first virtual box being identified as being in the first shape among the specified shapes. For example, the processor 110 may set the line segment of the first virtual box corresponding to the rear surface of the external vehicle as the reference line segment.

In an example, the processor 110 may identify at least one of a width of the first virtual box, or a length of the first virtual box, or any combination thereof. For example, the processor 110 may identify the local minimum contour points on each of a plurality of first layers based on the width of the first virtual box exceeding a first reference width and the length of the first virtual box exceeding a first reference length.

In an example, the processor 110 may identify a global minimum contour point, which has the smallest length between the reference line segment and each of local minimum contour points, from among local minimum contour points.

In an example, the processor 110 may identify a layer including the global minimum contour point. The processor 110 may store information associated with a layer, on which the global minimum contour point is identified, from among the plurality of first layers in the memory 130. For example, the Information associated with the layer on which the global minimum contour point is identified may include a layer number of the layer, on which the global minimum contour point is identified, from among the plurality of first layers.

In an example, the processor 110 may identify the local minimum contour points included in each of the plurality of first layers. The processor 110 may determine whether a distance between the reference line segment and each of local minimum contour points included in each of the plurality of first layers exceeds a first reference distance. The processor 110 may identify a minimum value of the third axis direction among the second contour points based on the fact that the distance between the reference line segment and each of the local minimum contour points included in each of the plurality of first layers exceeds the first reference distance. For example, the minimum value of the third axis direction may include the coordinates of the global minimum contour point in the third axis direction.

In an example, the processor 110 may form a plurality of second layers different from the plurality of first layers by setting a layer including the minimum value of the third axis direction as a minimum layer based on identifying the minimum value of the third axis direction among the second contour points. For example, the processor 110 may form the plurality of second layers based on the minimum value of the third axis direction.

In an example, the processor 110 may create a second virtual box based on second contour points included in the plurality of second layers.

In an example, the processor 110 may perform a validation check on the second virtual box created based on the second contour points. The processor 110 may output the second virtual box or the first virtual box based on the result of performing the validation check on the second virtual box.

Hereinafter, an example of obtaining a second virtual box based on the distribution of the first contour points included in the first virtual box identified as being in a second shape (e.g., I-shape) among the specified shapes will be described later.

In an example, the processor 110 may identify that the distribution of the first contour points included in the first virtual box is in the second shape (e.g., I-shape) different from the first shape (e.g., L-shape) among the specified shapes (e.g., L-shape or I-shape).

In an example, the processor 110 may identify a minimum value and a maximum value of the second axis direction of the first contour points on each of the plurality of first layers. The processor 110 may identify the distance between each of the first contour points and a line segment connecting the minimum value and the maximum value of the first contour points in the second axis direction, on each of the plurality of first layers.

In an example, the processor may identify a partial shape (e.g., I′-shape) included in the second shape based on the fact that the distance between each of the first contour points and the line segment connecting the minimum value and the maximum value of the first contour points in the second axis direction is identified as being within a reference distance, on each of the plurality of first layers.

In an example, the processor 110 may identify layers including the partial shape included in the second shape based on performing an operation of identifying the partial shape included in the second shape, on each of the plurality of first layers.

In an example, the processor 110 may identify a reference line segment corresponding to the side surface of the external vehicle. Hereinafter, a first reference line segment and a second reference line segment are separately described because side surfaces of the external vehicle include a left side surface and a right side surface.

In an example, the processor 110 may identify the first line segment and the second line segment, which correspond to the side surfaces of an external vehicle, on at least one of the layers including the partial shape.

The processor 110 may identify a first length between the first line segment and a first point corresponding to the minimum value of the second axis direction forming the partial shape. The processor 110 may identify a second length between the first line segment and a second point corresponding to the maximum value of the second axis direction forming the partial shape.

The processor 110 may identify a first minimum length, which is relatively small, from among the first length and the second length.

The processor 110 may identify a third length between the second line segment and the first point corresponding to the minimum value of the second axis direction forming the partial shape. The processor 110 may identify a fourth length between the second line segment and the second point corresponding to the maximum value of the second axis direction forming the partial shape.

The processor 110 may identify a second minimum length, which is relatively small, from among the third length and the fourth length.

In an example, the processor 110 may compare the first minimum length with the second minimum length. For example, the processor 110 may identify a length, which is relatively small, from among the first minimum length and the second minimum length. In an example, the processor 110 may identify a line segment forming a length, which is relatively small, from among the first minimum length and the second minimum length. The processor 110 may set a line segment forming a length, which is relatively small, from among the first minimum length and the second minimum length as the first reference line segment.

In an example, the processor 110 may identify at least one layer, on which a partial shape is not identified, from among the plurality of first layers. The processor 110 may identify a distance between the first reference line segment and each of the first contour points on at least one layer, on which the partial shape is not identified, from among the plurality of first layers.

The processor 110 may identify a third point corresponding to the minimum value of the second axis direction among the first contour points, on at least one layer, on which the partial shape is not identified, from among the plurality of first layers. The processor 110 may identify a fourth point corresponding to the maximum value of the second axis direction among the first contour points, on at least one layer, on which the partial shape is not identified, from among the plurality of first layers.

In an example, the processor 110 may form a first virtual box and may identify a second reference line segment facing the first reference line segment. In an example, the processor 110 may identify a fifth length between the first reference line segment and the third point. The processor 110 may identify a sixth length between the first reference line segment and the fourth point. The processor 110 may identify a seventh length between the second reference line segment and the third point. The processor 110 may identify an eighth length between the second reference line segment and the fourth point.

In an example, the processor 110 may identify the smallest length among the fifth length, the sixth length, the seventh length, and the eighth length, and may determine whether a line segment forming the smallest length among the fifth length, the sixth length, the seventh length, and the eighth length is the first reference line segment. The processor 110 may identify a point forming the smallest length among the fifth length, the sixth length, the seventh length, and the eighth length as the global minimum contour point based on the fact that the line segment forming the smallest length among the fifth length, the sixth length, the seventh length, and the eighth length is the first reference line segment. The processor 110 may identify a contour point set including the global minimum contour point. The processor 110 may obtain second contour points, which are obtained by excluding the contour point set including the global minimum contour point, from among the first contour points based on identifying the contour point set including the global minimum contour point.

The processor 110 may create a second virtual box based on the obtained second contour points.

To sum up the above-mentioned details, in an example, the processor 110 may identify (or set), as the first reference line segment, a line segment, which has the greatest distance from points forming the partial shape, from among line segments that correspond to side surfaces of the external vehicle and are used to form the first virtual box on at least one of layers including a partial shape.

On at least one layer, on which a partial shape is not identified, from among the plurality of first layers, the processor 110 may identify a first distance, which is smallest, from among distances of first contour points from the first reference line segment, and a second distance, which is smallest, from among distances of first contour points from the second reference line segment facing the first reference line segment among line segments forming the first virtual box.

The processor 110 may compare the first distance with the second distance. The processor 110 may determine whether the first distance is smaller than the second distance. The processor 110 may identify the global minimum contour point forming the first distance based on the first distance being identified as being smaller than the second distance. The processor 110 may obtain a contour point set including a global minimum contour point based on identifying the global minimum contour point.

The processor 110 may identify the minimum value of the third axis direction among the second contour points based on obtaining contour points, which are obtained by excluding the contour point set, from among the first contour points. The processor 110 may form a plurality of second layers different from the plurality of first layers by setting a layer including the minimum value of the third axis direction as a minimum layer.

In an example, the processor 110 may create a second virtual box based on second contour points included in the plurality of second layers.

In an example, the processor 110 may identify a distance between a reference line segment (e.g., the first reference line segment) and each of line points, which are included in a line box and to each of which a first identifier indicating a line is assigned, from among a plurality of first points.

The processor 110 may identify an invalid box having a second identifier indicating that the distribution of the first contour points is not one of the specified shapes (e.g., L-shape or I-shape).

The processor 110 may store, in the memory 130, at least one of second contour points, which are obtained by excluding at least part of the first contour points overlapping line points, from among the first contour points, or second contour points, which are obtained by excluding invalid points included in the invalid box, from among the first contour points, or any combination thereof.

In an example, the processor 110 may set a layer including the minimum value of the third axis direction as a minimum layer based on identifying the minimum value of the third axis direction among the second contour points. The processor 110 may form the plurality of second layers different from the plurality of first layers by setting a layer including the minimum value of the third axis direction as a minimum layer based on identifying the minimum value of the third axis direction among the second contour points.

In an example, the processor 110 may create the second virtual box based on the second contour points included in the plurality of second layers.

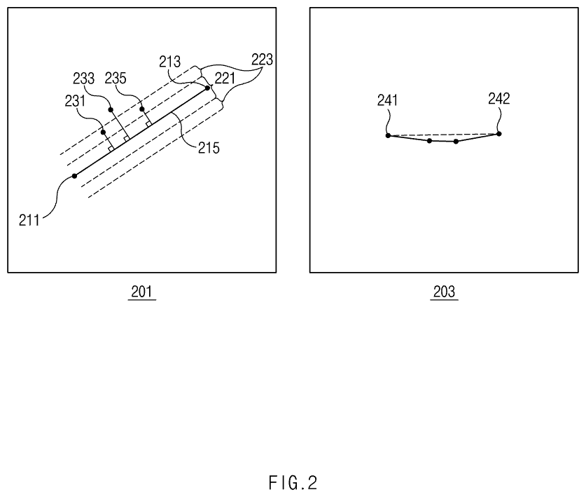

FIG. 2 shows an example of identifying a partial shape in an example of the present disclosure.

Referring to FIG. 2, a processor (e.g., the processor 110 in FIG. 1) of a vehicle control apparatus (e.g., the vehicle control apparatus 100 in FIG. 1) according to an example may identify contour points, which are arranged in a second shape different from a first shape among specified shapes, from among a plurality of points.

Descriptions in FIG. 2 may include operations performed by the processor on each of a plurality of layers.

A first example 201 in FIG. 2 may include an example for identifying a partial shape of the second shape. A second example 203 of FIG. 2 may include an example of identifying the length of a line segment based on coordinates of the contour points in a direction of a second axis among a first axis, the second axis, and a third axis. The first axis may be parallel to the longitudinal axis of a vehicle comprising the processor. The second axis may be parallel to the transverse axis of the vehicle comprising the processor. The third axis may be parallel to the vertical axis of a vehicle comprising the processor.

For example, the first shape may include L-shape. For example, the L-shape may include an array of contour points arranged in an ‘L’ shape. For example, the second shape may include an I-shape. For example, the I-shape may include an array of contour points arranged in an ‘I’ shape.

Referring to the first example 201 of FIG. 2, in an example, the processor may identify distribution characteristics of contour points forming the second shape. For example, the processor may identify the parallel distribution of contour points forming the second shape.

The processor may identify a first point 211 and a second point 213. For example, the distance (e.g., the shortest length) between the first point 211 and the second point 213 may be smaller than a width (e.g., about 4 m) corresponding to a lane. For example, the first point 211 and the second point 213 may include some of a plurality of points identified by LiDAR (e.g., the LiDAR 120 in FIG. 1). For example, the first point 211 may correspond to the minimum value of a direction of the second axis among the first axis, the second axis, and the third axis. For example, the second point 213 may correspond to the maximum value of a direction of the second axis among the first axis, the second axis, and the third axis. The second axis may be parallel to the transverse axis of a vehicle comprising the processor.

In an example, the processor may identify a line segment 215 connecting the first point 211 and the second point 213. The processor may identify a distance between the line segment 215 and each of contour points 231, 233, and 235.

For example, the processor may identify the distance between the line segment 215 and each of the contour points 231, 233, and 235 based on Equation 1 below.

$$d = \frac{\vert {A}_{1} {x}_{j} + ( - 1 ) \cdot {y}_{j} + {A}_{2} \vert}{\sqrt{{A}_{1}^{2} + 1}} \qquad [ Equation 1 ]$$

In Equation 1, ‘d’ may include the distance between the line segment 215 and each of the contour points 231, 233, and 235. A₁ and (−1) may include values associated with a slope of the line segment 215. For example, the slope of the line segment 215 may include

$$\vert \frac{{A}_{1}}{( - 1 )} \vert .$$

xⱼ may include the coordinates of a first axis direction of one of the contour points 231, 233, and 235. yⱼ may include the coordinates of a second axis direction of one of the contour points 231, 233, and 235. A₂ may include an intercept of the second axis direction of the line segment 215.

In an example, the processor may identify contour points located in a first area 221 or a second area 223 based on identifying the distance between the line segment 215 and each of the contour points 231, 233, and 235. For example, the first area 221 may include an area included within a first specified distance (e.g., approximately 0.025 m) from the line segment 215. For example, the second area 223 may include an area that exceeds the first specified distance from the line segment 215 and included within the second specified distance (e.g., approximately 0.05 m). For example, a third area may include an area outside the second area 223.

Referring to the second example 203 in FIG. 2, in an example, among the contour points, the processor may identify a point 241 corresponding to the minimum value of a direction of the second axis, and a point 242 corresponding to the maximum value of the direction of the second axis among the first axis, the second axis, and the third axis. For example, the processor may perform an operation of analyzing the distribution characteristics of contour points forming the second shape described in the first example 201 of FIG. 2 based on a distance between the point 241 corresponding to the minimum value of the second axis direction and the point 242 corresponding to the maximum value of the second axis direction being smaller than a width (e.g., about 4 m) corresponding to a lane.

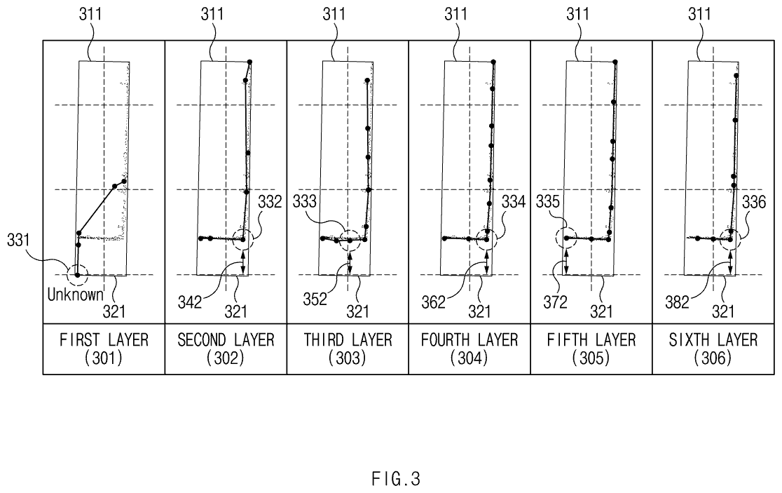

FIG. 3 shows an example of obtaining a contour point set, in an example of the present disclosure.

Referring to FIG. 3, a processor (e.g., the processor 110 in FIG. 1) included in a vehicle control apparatus (e.g., the vehicle control apparatus 100 in FIG. 1) according to an example may identify contour points included in a plurality of layers 301, 302, 303, 304, 305, and 306.

For example, the processor may identify a virtual box, which includes a plurality of layers having the specified number (e.g., about 6) or more and in which a first shape among specified shapes is identified as many as the specified number (e.g., about 2) or more. The processor may identify a size of the virtual box, which includes a plurality of layers having the specified number (e.g., about 6) or more and in which the first shape among specified shapes is identified as many as the specified number (e.g., about 2) or more. For example, the processor may identify a minimum distance between a base line of the virtual box and contour points based on a determination that a width of the virtual box exceeds a reference width (e.g., approximately 1.5 m) and a length of the virtual box exceeds a reference length (e.g., approximately 1.5 m).

For example, the processor may identify a first point 331, which has the minimum distance from a base line 321 of a virtual box 311, among contour points identified on the first layer 301.

For example, the processor may identify a second point 332, which has a minimum distance 342 from the base line 321 of the virtual box 311, from among contour points identified on the second layer 302.

For example, the processor may identify a third point 333, which has a minimum distance 352 from the base line 321 of the virtual box 311, from among contour points identified on a third layer 303.

For example, the processor may identify a fourth point 334, which has a minimum distance 362 from the base line 321 of the virtual box 311, from among contour points identified on a fourth layer 304.

For example, the processor may identify a fifth point 335, which has a minimum distance 372 from the base line 321 of the virtual box 311, from among contour points identified on a fifth layer 305.

For example, the processor may identify a sixth point 336, which has a minimum distance 382 from the base line 321 of the virtual box 311, from among contour points identified on a sixth layer 306.

In an example, the processor may identify points 331, 332, 333, 334, 335, and 336 having a minimum distance from the base line 321 of the virtual box 311, from among contour points included in the virtual box 311 within a plurality of first layers included in the virtual box 311.

For example, the processor may identify the first point 331, which has the minimum distance from the base line 321, from among points 331, 332, 333, 334, 335, and 336 with the minimum distance from the base line 321 of the virtual box 311 based on identifying the points 331, 332, 333, 334, 335, and 336 having the minimum distance from the base line 321 of the virtual box 311 within the plurality of first layers included in the virtual box 311. For example, the processor may identify a contour point set including the first point 331. For example, the contour point set including the first point 331 may include noise.

In an example, the processor may store information associated with the first layer 301, which includes the first point 331, in a memory (e.g., the memory 130 in FIG. 1) based on identifying the first point 331, which has the minimum distance from the base line 321, from among the points 331, 332, 333, 334, 335, and 336 that have a minimum distance from the base line 321 of the virtual box 311. For example, the processor may store an identifier assigned to the first layer 301 in the memory.

In an example, the processor may identify a contour point set identified in a height area including the first layer 301 including the first point 331. For example, the height area may include an area based on a third axis among a first axis, a second axis, and the third axis. For example, the processor may create a virtual box different from the virtual box 311 based on excluding the contour point set identified in the height area from the contour points included in the virtual box 311. For example, the virtual box 311 may be referred to as a “first virtual box”. A virtual box different from the virtual box 311 may be referred to as a “second virtual box”.

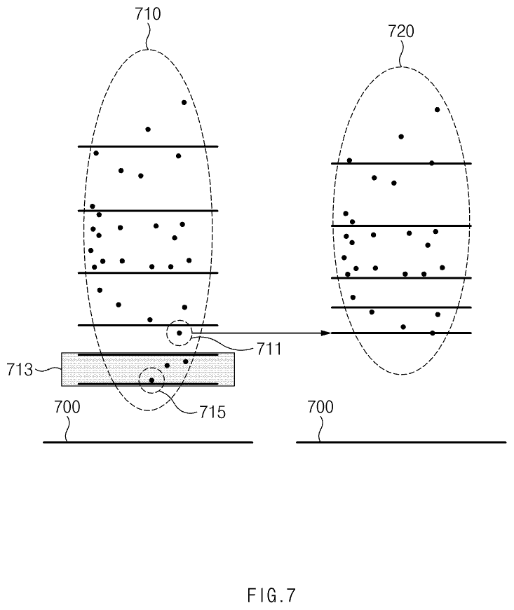

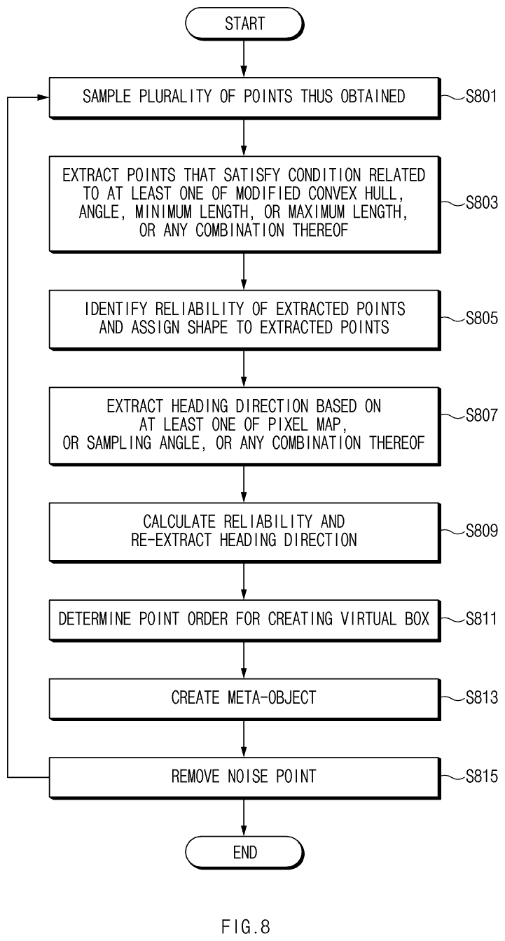

Descriptions of creating a virtual box different from the virtual box 311 based on excluding the contour point set identified in the height area from the contour points included in the virtual box 311 are given later in FIGS. 7 and 8.

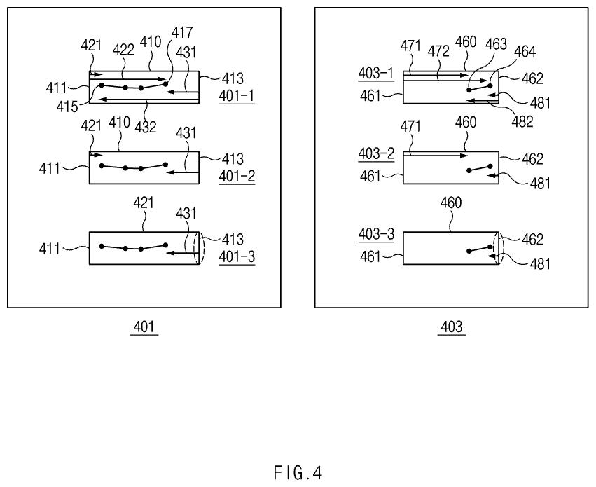

FIG. 4 shows an example of obtaining a contour point set, in an example of the present disclosure.

Referring to FIG. 4, a processor (e.g., the processor 110 in FIG. 1) included in a vehicle control apparatus (e.g., the vehicle control apparatus 100 in FIG. 1) according to an example may identify a reference line segment based on a determination that contour points included in a virtual box 410 have the distribution of a second shape different from a first shape among specified shapes. For example, the processor may perform an operation associated with a first example 401 below contour points with the on each of layers including distribution of a partial shape included in the second shape.

Referring to the first example 401 in FIG. 4, in an example, the processor may identify line segments 411 and 413 corresponding to side surfaces of an external vehicle among line segments forming the virtual box 410. The processor may identify a first point 415 having the minimum value of the direction of a second axis and a second point 417 having the maximum value of a direction of the second axis among a first axis, the second axis, and a third axis from among contour points included in the virtual box 410 from the line segments 411 and 413. The first axis may be parallel to the longitudinal axis of a vehicle comprising the processor. The second axis may be parallel to the transverse axis of the vehicle comprising the processor. The third axis may be parallel to the vertical axis of a vehicle comprising the processor.

Referring to a first operation 401-1 of the first example 401, the processor may identify a first length 421 between the first line segment 411 and the first point 415. The processor may identify a second length 422 between the first line segment 411 and a second point 417.

The processor may identify a third length 431 between a second line segment 413 and the second point 417. The processor may identify fourth length 432 between the second line segment 413 and the first point 415.

Referring to a second operation 401-2 of the first example 401, the processor may identify the first length 421, which is relatively short, from among the first length 421 and the second length 422. The processor may identify the third length 431, which is relatively short, from among the third length 431 and the fourth length 432.

Referring to a third operation 401-3 of the first example 401, the processor may identify the third length 431, which is relatively long, from among the first length 421 and the third length 431. The processor may identify the second line segment 413 used to obtain the third length 431 as a reference line segment based on identifying the third length 431, which is relatively long, from among the first length 421 and the third length 431. For example, the processor may set the second line segment 413, which is used to obtain the third length 431, as the reference line segment.

A second example 403 of FIG. 4 may include an example of identifying a contour point set including second contour points to be excluded from the first contour points by using the reference line segment identified in the first example 401.

In an example, the processor may perform the following operations on each of layers different from layers, on each of which a partial shape included in the second shape is identified, in the first virtual box 460.

Referring to a first operation 403-1 of the second example 403, in an example, the processor may identify a first line segment 461 and a second line segment 462, which correspond to side surfaces of a host vehicle, from among line segments forming the virtual box.

The processor may identify a first point 463 having a minimum value of the second axis direction and a second point 464 having a maximum value of the second axis direction among points included in one of layers different from layers, on each of which a partial shape included in the second shape is identified.

In an example, the processor may identify a length between the first point 463 and the second point 464. The processor may identify a ratio between a width of the virtual box 460 and a length of the line segment connecting the first point 463 and the second point 464 based on identifying the width of the virtual box 460 and the length connecting the first point 463 and the second point 464. The processor may perform the following operations based on a determination that the ratio between the width of the virtual box 460 and the length of the line segment connecting the first point 463 and the second point 464 is smaller than or equal to a specified ratio (e.g., about 30%).

The processor may identify a first length 471 between the first line segment 461 and the first point 463 having the minimum value of the second axis direction. The processor may identify a second length 472 between the first line segment 461 and the second point 464 having the maximum value of the second axis direction.

The processor may identify a third length 481 between the second line segment 462 and the second point 464 having the maximum value of the second axis direction (e.g., the value increases as the point moves toward the right side in FIG. 4). The processor may identify a fourth length 482 between the second line segment 462 and the first point 463 having the minimum value of the second axis direction.

Referring to a second operation 403-2 of the second example 403, in an example, the processor may identify a relatively small length among the first length 471 and the second length 472 based on identifying the first length 471 and the second length 472. For example, the processor may identify the first length 471, which is relatively small, from among the first length 471 and the second length 472 based on identifying the first length 471 and the second length 472.

In an example, the processor may identify a relatively small length among the third length 481 and the fourth length 482 based on identifying the third length 481 and the fourth length 482. For example, the processor may identify the third length 481, which is relatively small, from among the third length 481 and the fourth length 482.

Referring to a third operation 403-3 of the second example 403, in an example, the processor may identify the relatively small length among the first length 471 and the third length 481 based on identifying the first length 471 and the third length 481. The processor may identify the third length 481, which is relatively small, from among the first length 471 and the third length 481.

The processor may identify a point and a line segment used to obtain the third length 481 based on identifying the third length 481. For example, the processor may identify the second line segment 462, which is used to obtain the third length 481, and the second point 464 having the maximum value. The processor may determine whether the second line segment 462 used to obtain the third length 481 is a reference line segment.

For example, the processor may determine whether the second line segment 462 is a reference line segment identified in the first example 401 of FIG. 4. The processor may assign an identifier to a contour point set, which is identified on the corresponding layer, based on the second line segment 462 being a reference line segment. For example, the processor may remove the contour point set, which is identified on the corresponding layer and to which the identifier is assigned, based on the second line segment 462 being the reference line segment. In another example, the processor may exclude the contour point set, which is identified on the corresponding layer and to which the identifier is assigned, from among first contour points included in the first virtual box 460 based on the second line segment 462 being the reference line segment.

In an example, the processor may obtain second contour points based on excluding the contour point set, which is identified on the corresponding layer and to which the identifier is assigned, from among the first contour points included in the first virtual box 460. The processor may create a second virtual box based on the obtained second contour points.

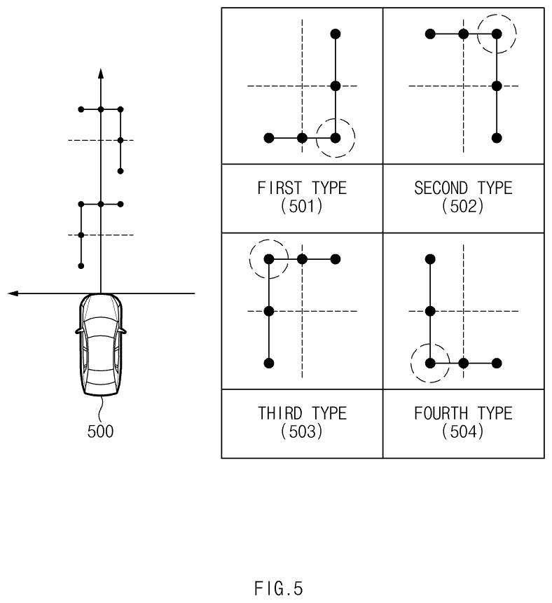

FIG. 5 shows an example associated with an invalid box, in an example of the present disclosure.

Referring to FIG. 5, a processor (e.g., the processor 110 in FIG. 1) included in a vehicle control apparatus (e.g., the vehicle control apparatus 100 in FIG. 1) according to an example may identify a virtual box corresponding to an external vehicle in front of a host vehicle 500.

In an example, the processor may identify the distribution of first contour points included in a virtual box. For example, the processor may identify the array of first contour points included in the virtual box.

In an example, the processor may identify that the distribution of the first contour points is of one type of a first type 501, a second type 502, a third type 503, and a fourth type 504. For example, the processor may assign an identifier based on the distribution of first contour points being identified as being of a specified type among the first type 501, the second type 502, the third type 503, and the fourth type 504.

For example, the specified type in FIG. 5 may include something other than one of the specified shapes described in FIG. 1.

In an example, the processor may identify that the distribution of the first contour points included in the virtual box is of the second type 502 or the third type 503. The processor may identify that the virtual box including the distribution of the first contour points having the second type 502 or the third type 503 is an invalid box, based on the distribution of first contour points being of the second type 502 or the third type 503.

The processor may not output a virtual box identified as an invalid box, or may remove layers including the distribution having the second type 502 or the third type 503.

Because the second type 502 or the third type 503 are types capable of being identified from the front of the host vehicle 500, the processor may stop tracking the virtual box including the distribution of the first contour points having the second type 502 or the third type 503 based on the distribution of first contour points identified as being of the second type 502 or the third type 503.

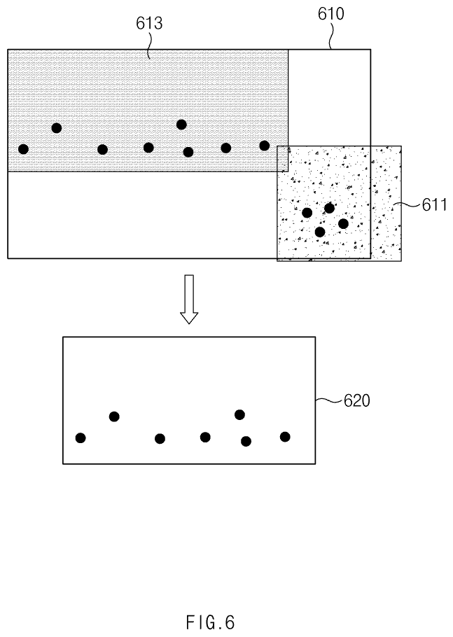

FIG. 6 shows an example associated with a line box, in an example of the present disclosure.

Referring to FIG. 6, a processor (e.g., the processor 110 in FIG. 1) included in a vehicle control apparatus (e.g., the vehicle control apparatus 100 in FIG. 1) according to an example may identify line points, which are included in a line box 611 and to which a first identifier indicating a line is assigned.

For example, the processor may identify the line box 611 that is at least partially included in a virtual box 610. The processor may identify line points included in the line box 611 at least partially included in the virtual box 610.

The processor may exclude the line points, which are included in the line box 611 at least partially included in the virtual box 610, from among first contour points. The processor may obtain second contour points 613 based on excluding the line points, which are included in the line box 611 at least partially included in the virtual box 610, from among the first contour points.

In an example, the processor may create a second virtual box 620 by using the obtained second contour points 613. The processor may output the created second virtual box 620, or may assign the second virtual box 620 to an external vehicle.

FIG. 7 shows an example of forming a plurality of second layers including second contour points, in an example of the present disclosure.

FIG. 7 may include an example of contour points identified on a plane including a third axis among a first axis, a second axis, and the third axis. A processor (e.g., the processor 110 in FIG. 1) of a vehicle control apparatus (e.g., the vehicle control apparatus 100 in FIG. 1) according to an example may identify first contour points 710 included in a virtual box. For example, the processor may identify the first contour points 710 spaced apart from a ground 700.

The processor may identify a point 715 having the minimum value of a third axis direction among the first contour points 710 based on identifying the first contour points 710.

For example, the processor may identify a layer 713 including the point 715 having the minimum value of the third axis direction. For example, the processor may identify the point 715 having the minimum value of the third axis direction based on the operations in FIGS. 3 and 4. The first axis may be parallel to the longitudinal axis of a vehicle comprising the processor. The second axis may be parallel to the transverse axis of the vehicle comprising the processor. The third axis may be parallel to the vertical axis of a vehicle comprising the processor.

The processor may sample the first contour points 710 corresponding to an external object. The processor may determine whether the sampled first contour points satisfy a condition associated with at least one of a convex hull, an angle, a minimum length, or a maximum length, or any combination thereof.

The processor may identify the reliability of the first contour points 710 that satisfy the condition associated with at least one of the modified convex hull, the angle, the minimum length, or the maximum length, or any combination thereof. For example, the processor may identify the reliability of the first contour points 710 based on tracking the virtual box including the first contour points 710.

In an example, the processor may identify the distribution (or array) of the first contour points 710. The processor may determine whether the distribution of the first contour points 710 forms a specified shape (e.g., L-shape or I-shape). On the basis of forming the specified shape, the processor may identify a heading direction based on at least one of a pixel map, or a sampling angle, or any combination thereof.

For example, the pixel map may include a map expressing the distribution of the first contour points 710. For example, the sampling angle may include an angle between reference points among the first contour points. For example, the reference points may include at least one of the minimum value of a first axis direction, the maximum value of the first axis direction, the minimum value of a second axis direction, or the maximum value of the second axis direction, or any combination thereof.

In an example, the processor may re-identify the reliability (e.g., one or more reliability values) of the first contour points and a heading direction. For example, the processor may re-identify at least one of the reliability of the first contour points, or the heading direction, or any combination thereof based on identifying the heading direction based on at least one of a pixel map, or a sampling angle, or any combination thereof. For example, the processor may perform the above-described operation again to perform a double check.

In an example, the processor may identify the virtual box including the first contour points and the order of the first contour points based on identifying the reliability of the first contour points and the heading direction. The virtual box including the first contour points may be referred to as a meta-object for tracking an external object.

In an example, the processor may perform an operation of removing noise included in the created meta-object. For example, the noise may include the contour point set described in FIGS. 3 and 4. The processor may obtain second contour points based on removing the noise. The processor may again perform the operations described in FIG. 7 based on obtaining the second contour points 720.

Hereinafter, a vehicle controlling method according to another example of the present disclosure will be described in detail with reference to FIG. 8. FIG. 8 shows an example associated with a flowchart of a vehicle control method, according to an example of the present disclosure.

Hereinafter, it is assumed that the vehicle control apparatus 100 of FIG. 1 performs the process of FIG. 8. In addition, in a description of FIG. 8, it may be understood that an operation described as being performed by a processor is controlled by the processor 110 the vehicle control apparatus 100.

In operation S801, a vehicle control method according to an example may include an operation of obtaining a plurality of points corresponding to an external object through LiDAR (e.g., the LiDAR 120 in FIG. 1). For example, the vehicle control method may include an operation of sampling the plurality of points thus obtained.

In operation S803, the vehicle control method according to an example may include an operation of extracting points that satisfy a condition associated with at least one of a modified convex hull, an angle, a minimum length, or a maximum length, or any combination thereof.

For example, the modified convex hull may include obtaining the smallest convex polygon including a plurality of points. For example, the modified convex hull may include obtaining a convex polygon including line segments connecting the plurality of points. For example, the angle described above may include an angle between line segments connecting the plurality of points. For example, the minimum length may include a minimum length among lengths of line segments connecting the plurality of points. For example, the maximum length may include a maximum length among lengths of line segments connecting the plurality of points.

In operation S805, the vehicle control method according to an example may include an operation of identifying reliability of points extracted in operation S803 and assigning a shape to the extracted points.

For example, the vehicle control method may include an operation of identifying the reliability of the extracted points based on tracking an external object associated with the extracted points, For example, the vehicle control method may include an operation of identifying the distribution of extracted points. For example, the vehicle control method may assign a shape to the extracted points based on identifying the distribution of the extracted points. For example, the shape may include a specified shape (e.g., L-shape or I-shape) described in FIG. 1.

In operation S807, the vehicle control method according to an example may include an operation of extracting a heading direction based on at least one of a pixel map, or a sampling angle, or any combination thereof.

For example, the pixel map may include a map expressing the distribution of the first contour points. For example, the sampling angle may include an angle between reference points among the first contour points. For example, the reference points may include at least one of the minimum value of the first axis direction, the maximum value of the first axis direction, the minimum value of the second axis direction, or the maximum value of the second axis direction, or any combination thereof.

In operation S809, the vehicle control method according to an example may include an operation of calculating the reliability of first contour points and re-extracting the heading direction.

In operation S811, the vehicle control method according to an example may include an operation of determining the point order for creating a virtual box. For example, the vehicle control method may include an operation of determining the order of first contour points.

For example, the vehicle control method may include an operation of determining the order of first contour points sequentially from the minimum value of the second axis direction counterclockwise and assigning an identifier to the first contour points in the determined order. For example, the vehicle control method may include an operation of assigning an identifier indicating the order of the first contour points to each of the first contour points.

In operation S813, the vehicle control method according to an example may include an operation of creating a meta-object. For example, the vehicle control method may include an operation of creating a meta-object based on assigning an identifier indicating the order of the first contour points to each of the first contour points. For example, the meta-object may include a virtual box for tracking an external object.

In operation S815, a vehicle control method according to an example may include an operation of removing a noise point. For example, the vehicle control method may include an operation of identifying a contour point set including noise points by using the operations described in FIGS. 3 and 4. For example, the vehicle control method may obtain second contour points based on removing the identified noise points.

In an example, the vehicle control method may repeatedly perform operation S801 to operation S815 or may terminate the operations, based on obtaining the second contour points.

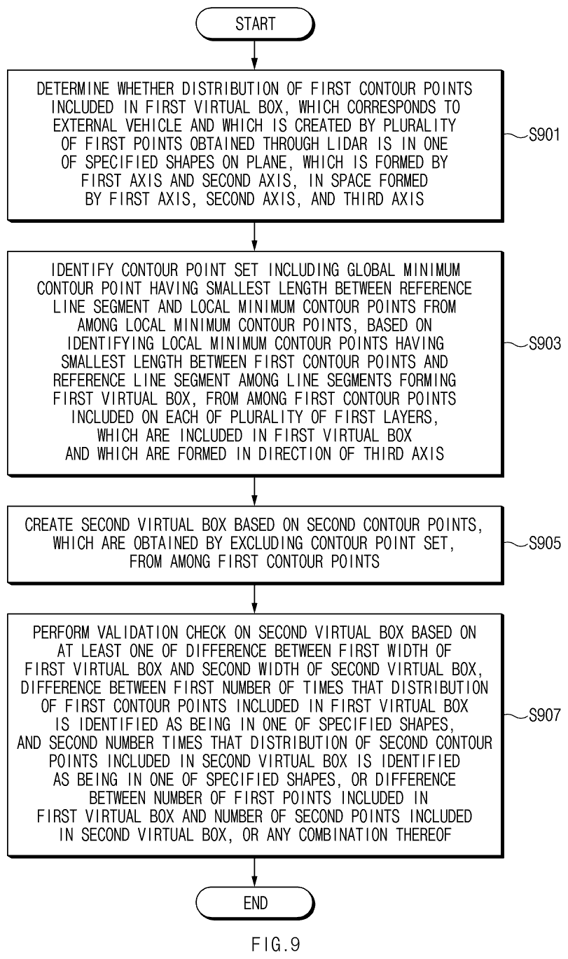

Hereinafter, a vehicle control method according to another example of the present disclosure will be described in detail with reference to FIG. 9. FIG. 9 shows an example associated with a flowchart of a vehicle control method, according to an example of the present disclosure.

Hereinafter, it is assumed that the vehicle control apparatus 100 of FIG. 1 performs the process of FIG. 9. In addition, in a description of FIG. 9, it may be understood that an operation described as being performed by a processor is controlled by the processor 110 of the vehicle control apparatus 100.

Referring to FIG. 9, in operation S901, a vehicle control method may include an operation of determining whether the distribution of first contour points included in a first virtual box created by a plurality of first points is in one of specified shapes on a plane, which is formed by the first axis and the second axis, in the space formed by the first axis, the second axis, and the third axis.

In operation 903, the vehicle control method may include an operation of identifying a contour point set including a global minimum contour point having the smallest length between a reference line segment and local minimum contour points from among the local minimum contour points, based on identifying the local minimum contour points having the smallest length between the first contour points and the reference line segment among line segments forming a first virtual box, from among the first contour points included on each of the plurality of first layers, which are included in the first virtual box and which are formed in a direction of the third axis.

For example, the reference line segment may include a line segment corresponding to a rear surface of the external vehicle or a side surface of the external vehicle among the line segments forming the first virtual box.

According to an example, the vehicle control method may include an operation of identifying (or setting) that a line segment of the first virtual box corresponding to a rear surface of the external vehicle is a reference line segment, based on the distribution of the first contour points included in the first virtual box being identified as being in the first shape among the specified shapes. The vehicle control method may include an operation of identifying the local minimum contour points on each of the plurality of first layers based on a width of the first virtual box exceeding a first reference width and a length of the first virtual box exceeding a first reference length.

According to an example, the vehicle control method may include an operation of storing information associated with a layer, on which the global minimum contour point is identified, from among the plurality of first layers in a memory (e.g., the memory 130 in FIG. 1).

According to an example, the vehicle control method may include an operation of setting a plurality of second layers different from the plurality of first layers by setting a layer including a minimum value of the direction of the third axis as a minimum layer based on identifying the minimum value of the direction of the third axis among the second contour points on the basis of the fact that a distance between the reference line segment and each of the local minimum contour points included in each of the plurality of first layers exceeds a first reference distance. The vehicle control method may include an operation of creating the second virtual box based on the second contour points included in the plurality of second layers.

According to an example, the vehicle control method may include an operation of identifying the distribution of the first contour points included in the first virtual box is in a second shape different from a first shape among the specified shapes.

The vehicle control method may include an operation of identifying a partial shape included in the second shape based on the fact that a distance between each of the first contour points and a line segment connecting a minimum value and a maximum value of a direction of the second axis of the first contour points is identified as being within a reference distance, on each of the plurality of first layers, when the distribution of the first contour points included in the first virtual box is in a second shape different from a first shape among the specified shapes. The vehicle control method may include an operation of identifying layers including the partial shape among the plurality of first layers.

According to an example, the vehicle control method may include an operation of identifying, as the first reference line segment, a line segment, which has the greatest distance from points forming the partial shape, from among line segments, which correspond to side surfaces of the external vehicle and are used to form the first virtual box, on at least one of layers including a partial shape. The vehicle control method may include an operation of identifying a first distance, which is smallest, from among distances of first contour points from the first reference line segment, and a second distance, which is smallest, from among distances of first contour points from the second reference line segment facing the first reference line segment among line segments forming the first virtual box, on at least one layer, on which a partial shape is not identified, from among the plurality of first layers.

The vehicle control method may include an operation of identifying the global minimum contour point forming the first distance based on the first distance being identified as being smaller than the second distance. The vehicle control method may include an operation of obtaining a contour point set including a global minimum contour point based on identifying the global minimum contour point. The vehicle control method may include an operation of identifying the minimum value of the third axis direction among the second contour points based on obtaining second contour points, which are obtained by excluding the contour point set, from among the first contour points. The vehicle control method may include an operation of forming a plurality of second layers different from the plurality of first layers by setting a layer including the minimum value of the direction of the third axis as a minimum layer.

According to an example, the vehicle control method may include an operation of identifying a distance between the reference line segment and line points, which are included in a line box and to each of which a first identifier indicating a line is assigned, from among the plurality of first points. The vehicle control method may include an operation of identifying an invalid box having a second identifier indicating that the distribution of the first contour points is not in one of the specified shapes.

According to an example, the vehicle control method may include an operation of storing, in the memory, at least one of second contour points, which are obtained by excluding at least part of the first contour points overlapping line points, from among the first contour points, or second contour points, which are obtained by excluding invalid points included in the invalid box, from among the first contour points, or any combination thereof.

According to an example, the vehicle control method may include an operation of forming a plurality of second layers different from the plurality of first layers by setting a layer including the minimum value of the third axis direction as a minimum layer based on identifying the minimum value of the third axis direction among the second contour points. The vehicle control method may include an operation of creating the second virtual box based on the second contour points included in the plurality of second layers.

In operation S905, the vehicle control method according to an example may include an operation of creating a second virtual box based on second contour points, which are obtained by excluding the contour point set, from among the first contour points.

In operation S907, the vehicle control method according to an example may include an operation of performing a validation check on the second virtual box based on at least one of a difference between a first width of the first virtual box and a second width of the second virtual box, a difference between the first number of times that a distribution of the first contour points included in the first virtual box is identified as being in one of specified shapes, and the second number times that a distribution of the second contour points included in the second virtual box is identified as being in one of the specified shapes, or a difference between the number of first points included in the first virtual box and the number of second points included in the second virtual box, or any combination thereof.

According to an example, the vehicle control method may include an operation of outputting the second virtual box based on the second virtual box being identified as being valid through the validation check. According to an example, the vehicle control method may include an operation of outputting the first virtual box based on the second virtual box being identified as being invalid through the validation check.

According to an example, the vehicle control method may include identifying that the second virtual box is valid, based on a fact that the difference between the first width of the first virtual box and the second width of the second virtual box is greater than or equal to a second reference width, the second number of times that the distribution of the second contour points included in the second virtual box identified as being in one of the specified shapes is greater than or equal to the first number of times that the distribution of the first contour points included in the first virtual box identified as being in one of the specified shapes, and the difference between the number of the plurality of first points included in the first virtual box and the number of the plurality of second points included in the second virtual box is smaller than or equal to a reference ratio.

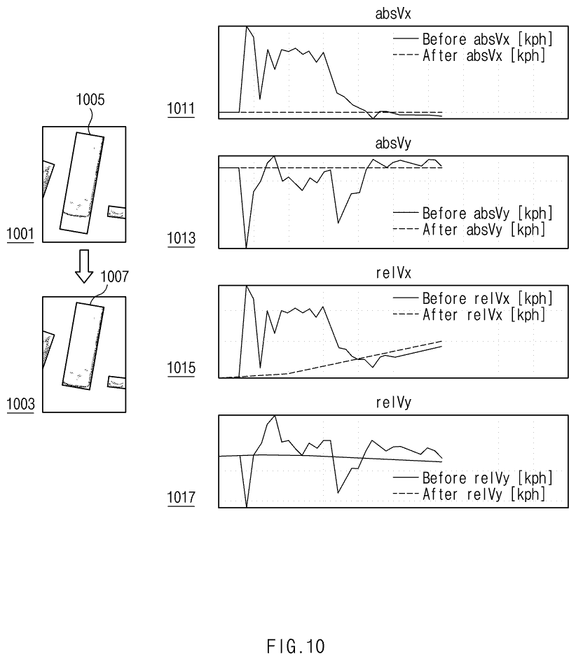

FIG. 10 shows an example of a result of applying the present disclosure.

A first example 1001 of FIG. 10 may include an example of not applying the present technology. A second example 1003 of FIG. 10 may include an example of applying the present technology.

Referring to the first example 1001 in FIG. 10, a size of a virtual box 1005 may be output such that the size of the virtual box 1005 is greater than a size of a virtual box 1007 in a second example 1003 of FIG. 10 due to noise.

Moreover, a first graph 1011, a second graph 1013, a third graph 1015, and a fourth graph 1017 of FIG. 10 may include graphs associated with speeds before and after the present technology is applied.

For example, the first graph 1011 of FIG. 10 may include an example associated with a longitudinal speed of an external vehicle. Referring to the first graph 1011 in FIG. 10, the first graph 1011 may include a graph in which the longitudinal speed of the external vehicle is output unstable before the present technology is applied, and the longitudinal speed of an external vehicle is output stably after the present technology is applied.

For example, the second graph 1013 of FIG. 10 may include an example associated with the lateral speed of the external vehicle. Referring to the second graph 1013 in FIG. 10, the second graph 1013 may include a graph in which the lateral speed of the external vehicle is output unstable before the present technology is applied, and the lateral speed of an external vehicle is output stably after the present technology is applied.

For example, the third graph 1015 of FIG. 10 may include an example associated with the relative longitudinal speed between the external vehicle and a host vehicle. Referring to the third graph 1015 in FIG. 10, the third graph 1015 includes a graph in which the relative longitudinal speed between the external vehicle and the host vehicle is output unstable before the present technology is applied, and the relative longitudinal speed between the external vehicle and the host vehicle is relatively stably output after the present technology is applied.

For example, the fourth graph 1017 of FIG. 10 may include an example associated with the relative lateral speed between the external vehicle and the host vehicle. Referring to the fourth graph 1017 in FIG. 10, the fourth graph 1017 includes a graph in which the relative lateral speed between the external vehicle and the host vehicle is output unstable before the present technology is applied, and the relative lateral speed between the external vehicle and the host vehicle is relatively stably output after the present technology is applied.

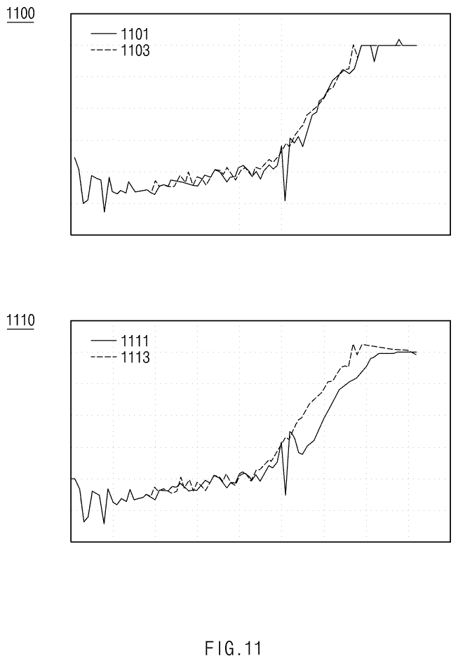

FIG. 11 shows an example of a result of applying the present disclosure.

A first graph 1100 of FIG. 11 may include an example associated with a heading direction of a meta-object. A second graph 1110 of FIG. 11 may include an example associated with a heading direction of a track-object. For example, the meta-object may include a virtual box before a virtual box is output. For example, the track-object may include the output virtual box.

In the first graph 1100, a first line 1101 may include the heading direction of the meta-object before the present technology is applied. The second line 1103 may include the heading direction of the meta-object after the present technology is applied.

Referring to the first graph 1100, the first graph 1100 may include a graph in which the heading direction of the meta-object is relatively stably output after the present technology is applied.

In the second graph 1110, a third line 1111 may include the heading direction of the track-object before the present technology is applied. A fourth line 1113 may include the heading direction of the track-object after the present technology is applied.

Referring to the second graph 1110, the second graph 1110 may include a graph in which the heading direction of the track-object is relatively stably output after the present technology is applied.

According to an aspect of the present disclosure, a vehicle control apparatus may include a light detection and ranging (LiDAR) configured to a plurality of first points corresponding to an external vehicle, and a processor. The processor may determine whether a distribution of first contour points included in a first virtual box created by the plurality of first points is in one of specified shapes on a plane, which is formed by a first axis and a second axis, in a space formed by the first axis, the second axis, and a third axis, may identify a contour point set including a global minimum contour point having the smallest length between a reference line segment and local minimum contour points from among the local minimum contour points, based on identifying the local minimum contour points having the smallest length between the first contour points and the reference line segment among line segments forming the first virtual box, from among the first contour points included in each of a plurality of first layers, which are included in the first virtual box and which are formed in a direction of the third axis, may create a second virtual box based on second contour points, which are obtained by excluding the contour point set, from among the first contour points, and may perform a validation check on the second virtual box based on at least one of a difference between a first width of the first virtual box and a second width of the second virtual box, a difference between the first number of times that the distribution of the first contour points included in the first virtual box is identified as being in one of the specified shapes, and the second number of times that a distribution of the second contour points included in the second virtual box is identified as being in one of the specified shapes, or a difference between the number of the plurality of first points included in the first virtual box and the number of the plurality of second points included in the second virtual box, or any combination thereof. The reference line segment may include a line segment corresponding to a rear surface or a side surface of the external vehicle among the line segments forming the first virtual box.

In an example, the processor may output the second virtual box based on the second virtual box being identified as being valid through the validation check, and may output the first virtual based on the second virtual box being identified as being invalid through the validation check.

In an example, the processor may identify that a line segment of the first virtual box corresponding to a rear surface of the external vehicle is the reference line segment, based on the distribution of the first contour points included in the first virtual box being identified as being in a first shape among the specified shapes and may identify the local minimum contour points on each of the plurality of first layers based on a width of the first virtual box exceeding a first reference width and a length of the first virtual box exceeding a first reference length.

According to an example, the vehicle control apparatus may further include a memory. The processor may store information associated with a layer, on which the global minimum contour point is identified, from among the plurality of first layers in the memory.

In an example, on a basis of a fact that a distance between the reference line segment and each of the local minimum contour points included in each of the plurality of first layers exceeds a first reference distance, the processor may form a plurality of second layers different from the plurality of first layers by setting a layer including a minimum value of the direction of the third axis as a minimum layer based on identifying the minimum value of the direction of the third axis among the second contour points, and may create the second virtual box based on the second contour points included in the plurality of second layers.

In an example, when the distribution of the first contour points included in the first virtual box is identified as being in a second shape different from a first shape among the specified shapes, the processor may identify a partial shape included in the second shape based on a fact that a distance between each of the first contour points and a line segment connecting a minimum value and a maximum value of a direction of the second axis of the first contour points is identified as being within a reference distance, on each of the plurality of first layers and may identify layers including the partial shape among the plurality of first layers.

In an example, the reference line segment may include a first reference line segment. The processor may identify, as the first reference line segment, a line segment, which has the greatest distance from points forming the partial shape, from among line segments, which correspond to side surfaces of the external vehicle and are used to form the first virtual box, on at least one of layers including a partial shape, may identify a first distance, which is smallest, from among distances of the first contour points from the first reference line segment, and a second distance, which is smallest, from among distances of the first contour points from the second reference line segment facing the first reference line segment among line segments forming the first virtual box on at least one layer, on which a partial shape is not identified, from among the plurality of first layers, may identify the global minimum contour point forming the first distance based on the first distance being identified as being smaller than the second distance, may obtain the contour point set including the global minimum contour point based on identifying the global minimum contour point, may identify a minimum value of the direction of the third axis among the second contour points based on obtaining the second contour points, which are obtained by excluding the contour point set, from among the first contour points, and may form a plurality of second layers different from the plurality of first layers by setting a layer including the minimum value of the direction of the third axis as a minimum layer.

The vehicle control apparatus according to an example may further include a memory. The processor may identify a distance between the reference line segment and line points, which are included in a line box and to each of which a first identifier indicating a line is assigned, from among the plurality of first points, may identify an invalid box having a second identifier indicating that the distribution of the first contour points is not in one of the specified shapes, and may store, in the memory, at least one of the second contour points, which are obtained by excluding at least part of the first contour points overlapping the line points, from among the first contour points, or the second contour points, which are obtained by excluding invalid points included in the invalid box, from among the first contour points, or any combination thereof.

In an example, the processor may form a plurality of second layers different from the plurality of first layers by setting a layer including a minimum value of the direction of the third axis as a minimum layer based on identifying the minimum value of the direction of the third axis among the second contour points, and may create the second virtual box based on the second contour points included in the plurality of second layers.

In an example, the processor may identify that the second virtual box is valid, based on a fact that the difference between the first width of the first virtual box and the second width of the second virtual box is greater than or equal to a second reference width, the second number of times that the distribution of the second contour points included in the second virtual box identified as being in one of the specified shapes is greater than or equal to the first number of times that the distribution of the first contour points included in the first virtual box identified as being in one of the specified shapes, and the difference between the number of the plurality of first points included in the first virtual box and the number of the plurality of second points included in the second virtual box is smaller than or equal to a reference ratio.

According to an aspect of the present disclosure, a vehicle control method may include determining whether a distribution of first contour points included in a first virtual box created by a plurality of first points is in one of specified shapes on a plane, which is formed by a first axis and a second axis, in a space formed by the first axis, the second axis, and a third axis based on obtaining the plurality of first points corresponding to an external vehicle through a LiDAR, identifying a contour point set including a global minimum contour point having the smallest length between a reference line segment and local minimum contour points from among the local minimum contour points, based on identifying the local minimum contour points having the smallest length between the first contour points and the reference line segment among line segments forming the first virtual box, from among the first contour points included in each of a plurality of first layers, which are included in the first virtual box and which are formed in a direction of the third axis, creating a second virtual box based on second contour points, which are obtained by excluding the contour point set, from among the first contour points, and performing a validation check on the second virtual box based on at least one of a difference between a first width of the first virtual box and a second width of the second virtual box, a difference between the first number of times that the distribution of the first contour points included in the first virtual box is identified as being in one of the specified shapes, and the second number of times that a distribution of the second contour points included in the second virtual box is identified as being in one of the specified shapes, or a difference between the number of the plurality of first points included in the first virtual box and the number of the plurality of second points included in the second virtual box, or any combination thereof. The reference line segment may include a line segment corresponding to a rear surface or a side surface of the external vehicle among the line segments forming the first virtual box.

According to an example, the vehicle control method may include outputting the second virtual box based on the second virtual box being identified as being valid through the validation check, and outputting the first virtual box based on the second virtual box being identified as being invalid through the validation check.

According to an example, the vehicle control method may include identifying that a line segment of the first virtual box corresponding to a rear surface of the external vehicle is the reference line segment, based on the distribution of the first contour points included in the first virtual box being identified as being in a first shape among the specified shapes, and identifying the local minimum contour points on each of the plurality of first layers based on a width of the first virtual box exceeding a first reference width and a length of the first virtual box exceeding a first reference length.

According to an example, the vehicle control method may include storing information associated with a layer, on which the global minimum contour point is identified, from among the plurality of first layers in a memory.

According to an example, the vehicle control method may include forming a plurality of second layers different from the plurality of first layers by setting a layer including a minimum value of the direction of the third axis as a minimum layer based on identifying the minimum value of the direction of the third axis among the second contour points, and creating the second virtual box based on the second contour points included in the plurality of second layers on a basis of a fact that a distance between the reference line segment and each of the local minimum contour points included in each of the plurality of first layers exceeds a first reference distance.

According to an example, the vehicle control method may include identifying a partial shape included in the second shape based on a fact that a distance between each of the first contour points and a line segment connecting a minimum value and a maximum value of a direction of the second axis of the first contour points is identified as being within a reference distance, on each of the plurality of first layers and identifying layers including the partial shape among the plurality of first layers when the distribution of the first contour points included in the first virtual box is identified as being in a second shape different from a first shape among the specified shapes.

In an example, the reference line segment may include a first reference line segment. The vehicle control method may include identifying, as the first reference line segment, a line segment, has the greatest distance from points forming the partial shape, from among line segments, which correspond to side surfaces of the external vehicle and are used to form the first virtual box, on at least one of layers including a partial shape, identifying a first distance, which is smallest, from among distances of the first contour points from the first reference line segment, and a second distance, which is smallest, from among distances of the first contour points from the second reference line segment facing the first reference line segment among line segments forming the first virtual box on at least one layer, on which a partial shape is not identified, from among the plurality of first layers, identifying the global minimum contour point forming the first distance based on the first distance being identified as being smaller than the second distance, obtaining the contour point set including the global minimum contour point based on identifying the global minimum contour point, identifying a minimum value of the direction of the third axis among the second contour points based on obtaining the second contour points, which are obtained by excluding the contour point set, from among the first contour points, and forming a plurality of second layers different from the plurality of first layers by setting a layer including the minimum value of the direction of the third axis as a minimum layer.

According to an example, the vehicle control method may include identifying a distance between the reference line segment and line points, which are included in a line box and to each of which a first identifier indicating a line is assigned, from among the plurality of first points, identifying an invalid box having a second identifier indicating that the distribution of the first contour points is not in one of the specified shapes, and storing, in a memory, at least one of the second contour points, which are obtained by excluding at least part of the first contour points overlapping the line points, from among the first contour points, or the second contour points, which are obtained by excluding invalid points included in the invalid box, from among the first contour points, or any combination thereof.

According to an example, the vehicle control method may include forming a plurality of second layers different from the plurality of first layers by setting a layer including a minimum value of the direction of the third axis as a minimum layer based on identifying the minimum value of the direction of the third axis among the second contour points, and creating the second virtual box based on the second contour points included in the plurality of second layers.

According to an example, the vehicle control method may include identifying that the second virtual box is valid, based on a fact that the difference between the first width of the first virtual box and the second width of the second virtual box is greater than or equal to a second reference width, the second number of times that the distribution of the second contour points included in the second virtual box identified as being in one of the specified shapes is greater than or equal to the first number of times that the distribution of the first contour points included in the first virtual box identified as being in one of the specified shapes, and the difference between the number of the plurality of first points included in the first virtual box and the number of the plurality of second points included in the second virtual box is smaller than or equal to a reference ratio.

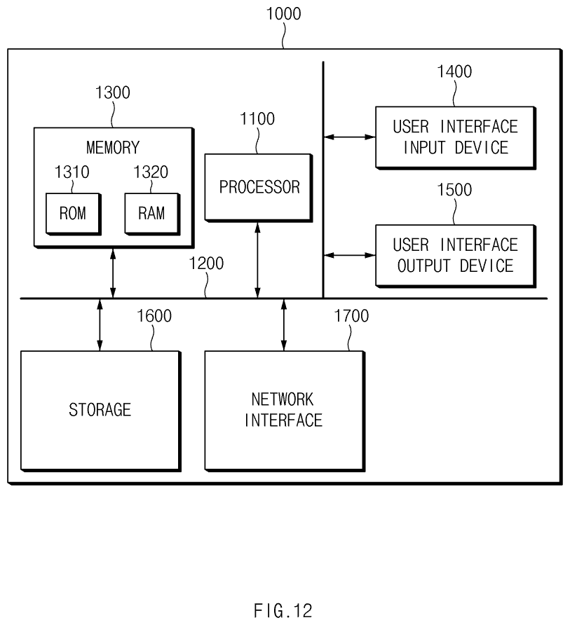

FIG. 12 illustrates a computing system associated with a vehicle control apparatus or vehicle control method, according to an example of the present disclosure.

Referring to FIG. 12, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the examples of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

The present technology may improve the location accuracy of an external vehicle by removing points corresponding to noise and then creating a virtual box.

Moreover, the present technology may improve the accuracy of at least one of a longitudinal speed, or a lateral speed, or any combination thereof of the external vehicle by removing points corresponding to noise and then creating a virtual box.

Furthermore, the present technology may stably output a heading direction of a virtual box corresponding to the external vehicle by removing points corresponding to noise and then creating the virtual box.

Besides, a variety of effects directly or indirectly understood through the specification may be provided.

Hereinabove, although the present disclosure has been described with reference to exemplary examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus comprising:
a sensor configured to obtain sensing information associated with a plurality of first points corresponding to an external vehicle; and
a processor configured to:
determine whether a distribution of first contour points included in a first virtual box associated with the plurality of first points corresponds to one of specified shapes on a plane, wherein the plane is formed by a first axis and a second axis, in a space formed by the first axis, the second axis, and a third axis;
determine a contour point set including a global minimum contour point, wherein the global minimum contour point is one of local minimum contour points and has the smallest distance among distances between a reference line segment and the local minimum contour points, wherein the local minimum contour points are determined, from among the first contour points, based on the smallest distance among distances between the first contour points and one of line segments forming the first virtual box, wherein the reference line segment corresponds to the one of the line segments forming the first virtual box and corresponds to a rear surface or a side surface of the external vehicle, wherein the first contour points are included in each of a plurality of first layers, and wherein the plurality of first layers are included in the first virtual box and formed in a direction of the third axis;
generate a second virtual box based on second contour points, wherein the second contour points are obtained by excluding the contour point set, from among the first contour points; and
perform a validation check on the second virtual box based on at least one of:
a difference between a first width of the first virtual box and a second width of the second virtual box,
a difference between a first number of times that the distribution of the first contour points included in the first virtual box is identified as being in one of the specified shapes and a second number of times that a distribution of the second contour points included in the second virtual box is identified as being in one of the specified shapes, or
a difference between a number of the plurality of first points included in the first virtual box and a number of a plurality of second points included in the second virtual box.

2. The apparatus of claim 1, wherein the processor is configured to:
output the second virtual box based on the second virtual box being identified as being valid after the validation check; or
output the first virtual box based on the second virtual box being identified as being invalid after the validation check.

3. The apparatus of claim 1, wherein the processor is configured to:
determine that a line segment of the first virtual box corresponding to a rear surface of the external vehicle is the reference line segment, based on the distribution of the first contour points included in the first virtual box being identified as being in a first shape among the specified shapes; and
identify the local minimum contour points on the plurality of first layers based on a width of the first virtual box exceeding a first reference width and a length of the first virtual box exceeding a first reference length.

4. The apparatus of claim 3, further comprising:
a memory,
wherein the processor is configured to:
store, in the memory, information associated with a layer, on which the global minimum contour point is identified, from among the plurality of first layers.

5. The apparatus of claim 3, wherein the processor is configured to:
based on a distance between the reference line segment and each of the local minimum contour points included in each of the plurality of first layers exceeding first reference distance, form a plurality of second layers different from the plurality of first layers by setting a layer including a minimum value of the direction of the third axis as a minimum layer based on identifying the minimum value of the direction of the third axis among the second contour points; and
generate the second virtual box based on the second contour points included in the plurality of second layers.

6. The apparatus of claim 1, wherein the processor is configured to:
identify, on each of the plurality of first layers, a partial shape included in a second shape based on a distance between each of the first contour points and a line segment connecting a minimum value and a maximum value of a direction of the second axis of the first contour points being identified as being within a reference distance, wherein the distribution of the first contour points included in the first virtual box is identified as being in the second shape different from a first shape among the specified shapes; and
identify layers including the partial shape among the plurality of first layers.

7. The apparatus of claim 6, wherein the reference line segment includes a first reference line segment, and
wherein the processor is configured to:
identify, as the first reference line segment, a line segment, which has the greatest distance from points forming the partial shape, from among line segments, which correspond to side surfaces of the external vehicle and are used to form the first virtual box, on at least one of layers including a partial shape;
identify a first distance, which is smallest, from among distances of the first contour points from the first reference line segment, and a second distance, which is smallest, from among distances of the first contour points from a second reference line segment facing the first reference line segment among line segments forming the first virtual box on at least one layer, on which a partial shape is not identified, from among the plurality of first layers;
identify the global minimum contour point forming the first distance based on the first distance being identified as being smaller than the second distance;
obtain the contour point set including the global minimum contour point based on identifying the global minimum contour point;
identify a minimum value of the direction of the third axis among the second contour points based on the second contour points, which are obtained by excluding the contour point set, from among the first contour points; and
form a plurality of second layers different from the plurality of first layers by setting a layer including the minimum value of the direction of the third axis as a minimum layer.

8. The apparatus of claim 6, further comprising:
a memory,
wherein the processor is configured to:
identify a distance between the reference line segment and line points, which are included in a line box and to each of which a first identifier indicating a line is assigned, from among the plurality of first points;
identify an invalid box having a second identifier indicating that the distribution of the first contour points is not in one of the specified shapes; and
store, in the memory, at least one of the second contour points, which are obtained by excluding at least part of the first contour points overlapping the line points, from among the first contour points, or the second contour points, which are obtained by excluding invalid points included in the invalid box, from among the first contour points, or any combination thereof.

9. The apparatus of claim 8, wherein the processor is configured to:
form a plurality of second layers different from the plurality of first layers by setting a layer including a minimum value of the direction of the third axis as a minimum layer based on identifying the minimum value of the direction of the third axis among the second contour points; and
generate the second virtual box based on the second contour points included in the plurality of second layers.

10. The apparatus of claim 1, wherein the processor is configured to:
identify that the second virtual box is valid, based on the difference between the first width of the first virtual box and the second width of the second virtual box being greater than or equal to a second reference width, the second number of times that the distribution of the second contour points included in the second virtual box identified as being in one of the specified shapes being greater than or equal to the first number of times that the distribution of the first contour points included in the first virtual box identified as being in one of the specified shapes, and the difference between the number of the plurality of first points included in the first virtual box and the number of the plurality of second points included in the second virtual box being smaller than or equal to a reference ratio.

11. A method comprising:
determining, by an apparatus, whether a distribution of first contour points included in a first virtual box associated with a plurality of first points corresponds to one of specified shapes on a plane, wherein the plane is formed by a first axis and a second axis, in a space formed by the first axis, the second axis, and a third axis, and wherein the plurality of first points corresponds to an external vehicle and obtained based on sensing information of a sensor;
determining a contour point set including a global minimum contour point, wherein the global minimum contour point is one of local minimum contour points and has the smallest distance among distances between a reference line segment and the local minimum contour points, wherein the local minimum contour points are determined, from among the first contour points, based on the smallest distance among distances between the first contour points and one of line segments forming the first virtual box, wherein the reference line segment corresponds to the one of the line segments forming the first virtual box and corresponds to a rear surface or a side surface of the external vehicle, wherein the first contour points are included in each of a plurality of first layers, and wherein the plurality of first layers are included in the first virtual box and formed in a direction of the third axis;
generating a second virtual box based on second contour points, wherein the second contour points are obtained by excluding the contour point set, from among the first contour points; and
performing a validation check on the second virtual box based on at least one of:
a difference between a first width of the first virtual box and a second width of the second virtual box,
a difference between a first number of times that the distribution of the first contour points included in the first virtual box is identified as being in one of the specified shapes and a second number of times that a distribution of the second contour points included in the second virtual box is identified as being in one of the specified shapes, or
a difference between a number of the plurality of first points included in the first virtual box and a number of the plurality of second points included in the second virtual box, or any combination thereof.

12. The method of claim 11, further comprising:
outputting the second virtual box based on the second virtual box being identified as being valid after the validation check; or
outputting the first virtual box based on the second virtual box being identified as being invalid after the validation check.

13. The method of claim 11, further comprising:
determining that a line segment of the first virtual box corresponding to a rear surface of the external vehicle is the reference line segment, based on the distribution of the first contour points included in the first virtual box being identified as being in a first shape among the specified shapes; and
identifying the local minimum contour points on the plurality of first layers based on a width of the first virtual box exceeding a first reference width and a length of the first virtual box exceeding a first reference length.

14. The method of claim 13, further comprising:
storing, in a memory, information associated with a layer, on which the global minimum contour point is identified, from among the plurality of first layers.

15. The method of claim 13, further comprising:
based on a distance between the reference line segment and each of the local minimum contour points included in each of the plurality of first layers exceeding a first reference distance, forming a plurality of second layers different from the plurality of first layers by setting a layer including a minimum value of the direction of the third axis as a minimum layer based on identifying the minimum value of the direction of the third axis among the second contour points; and
generating the second virtual box based on the second contour points included in the plurality of second layers.

16. The method of claim 11, further comprising:
identifying, on each of the plurality of first layers, a partial shape included in a second shape based on a distance between each of the first contour points and a line segment connecting a minimum value and a maximum value of a direction of the second axis of the first contour points being identified as being within a reference distance, wherein the distribution of the first contour points included in the first virtual box is identified as being in the second shape different from a first shape among the specified shapes; and
identifying layers including the partial shape among the plurality of first layers.

17. The method of claim 16, wherein the reference line segment includes a first reference line segment, and
wherein the method further comprises:
identifying, as the first reference line segment, a line segment, which has the greatest distance from points forming the partial shape, from among line segments, which correspond to side surfaces of the external vehicle and are used to form the first virtual box, on at least one of layers including a partial shape;
identifying a first distance, which is smallest, from among distances of the first contour points from the first reference line segment, and a second distance, which is smallest, from among distances of the first contour points from a second reference line segment facing the first reference line segment among line segments forming the first virtual box on at least one layer, on which a partial shape is not identified, from among the plurality of first layers;
identifying the global minimum contour point forming the first distance based on the first distance being identified as being smaller than the second distance;
obtaining the contour point set including the global minimum contour point based on identifying the global minimum contour point;
identifying a minimum value of the direction of the third axis among the second contour points based on the second contour points, which are obtained by excluding the contour point set, from among the first contour points; and
forming a plurality of second layers different from the plurality of first layers by setting a layer including the minimum value of the direction of the third axis as a minimum layer.

18. The method of claim 16, further comprising:
identifying a distance between the reference line segment and line points, which are included in a line box and to each of which a first identifier indicating a line is assigned, from among the plurality of first points;
identifying an invalid box having a second identifier indicating that the distribution of the first contour points is not in one of the specified shapes; and
storing, in a memory, at least one of the second contour points, which are obtained by excluding at least part of the first contour points overlapping the line points, from among the first contour points, or the second contour points, which are obtained by excluding invalid points included in the invalid box, from among the first contour points, or any combination thereof.

19. The method of claim 18, further comprising:
forming a plurality of second layers different from the plurality of first layers by setting a layer including a minimum value of the direction of the third axis as a minimum layer based on identifying the minimum value of the direction of the third axis among the second contour points; and
generating the second virtual box based on the second contour points included in the plurality of second layers.

20. The method of claim 11, further comprising:
identifying that the second virtual box is valid, based on the difference between the first width of the first virtual box and the second width of the second virtual box being greater than or equal to a second reference width, the second number of times that the distribution of the second contour points included in the second virtual box identified as being in one of the specified shapes being greater than or equal to the first number of times that the distribution of the first contour points included in the first virtual box identified as being in one of the specified shapes, and the difference between the number of the plurality of first points included in the first virtual box and the number of the plurality of second points included in the second virtual box is smaller than or equal to a reference ratio.
